(19) United States
(12) Patent Application Publication
(10) Pub. No.: US 2022/0331923 A1
(43) Pub. Date: Oct. 20, 2022

(54) METHOD FOR MACHINING A WORKPIECE BY MEANS OF A TOOL

(71) Applicant: MAGNA Powertrain GmbH & Co KG, Lannach (AT)

(72) Inventor: Christian FERRARI, Voitsberg (AT)

(21) Appl. No.: 17/700,551

(22) Filed: Mar. 22, 2022

(30) Foreign Application Priority Data
Apr. 14, 2021 (DE) 10 2021 203 688.0

(51) Int. Cl. B23Q 15/013

(52) U.S. Cl. CPC B23Q 15/013

(57) ABSTRACT

A method for machining a workpiece with at least one tool, wherein the workpiece and/or the tool are driven in rotation, wherein the tool has at least one cutting edge that is brought into cutting engagement with the workpiece, namely into a cutting position, in a cutting operation, and wherein, in the cutting operation, the workpiece or the tool is moved in a feed direction with a constant feed, and wherein, in a surface machining operation, the tool and thus the cutting edge remain in the cutting position and the workpiece or the tool is moved in the feed direction, shifted by half the feed.

### CROSS-REFERENCE TO RELATED APPLICATIONS

This application claims priority to German Application No. DE 10 2021 203 688.0, filed on Apr. 14, 2021 at the German Patent Office, and which is hereby incorporated by reference in its entirety.

### FIELD OF THE INVENTION

The present invention relates to a method for machining a workpiece with at least one tool, wherein the workpiece and/or the tool are driven in rotation, wherein the tool has at least one cutting edge that is brought into cutting engagement with the workpiece, namely into a cutting position, during a cutting operation, and wherein, during the cutting operation, the workpiece or the tool is moved in a feed direction with a constant feed.

### BACKGROUND OF THE INVENTION

This section provides information related to the present disclosure which is not necessarily prior art.

The machining of rotationally symmetric faces of a workpiece is usually carried out by turning or milling. The main difference between the two methods is the rotational movement of the workpiece or of the tool. Put simply, during turning, the workpiece rotates and the tool “rests”; while during milling, the tool rotates and the workpiece “rests”. However, mixed forms of these types of method are also known.

In longitudinal turning, for example, the workpiece is driven in rotation about an axis of rotation and the tool is fed in radially, namely normally to the axis of rotation, down to a cutting depth. During turning, the tool is moved with a feed movement parallel to the axis of rotation. During this turning, the rotationally symmetric face that is created obtains a “peak/valley” surface structure, which is referred to as twist.

This twist may be a drawback for example when shaft output points of motors, gearboxes and other machines are intended to be sealed off in the region of these surfaces by radially bearing sealing rings. Depending on the direction of rotation of the shaft, as a result of the twist, oil can pass out at the sealing point or dirt or water can pass in. Furthermore, in many applications, high mechanical stresses are expected, for example at teeth of gear wheels. In these cases, the “peaks” of the surface structure can be abrasively removed and undesired contamination occurs within the mechanical system.

### SUMMARY OF THE INVENTION

This section provides a general summary of the disclosure, and is not a comprehensive disclosure of its full scope or all of its features.

It is an object of the invention to provide an improved method for the machining of a workpiece with a tool.

This objective can be achieved by the subject matter of the present invention according to independent claim 1. Advantageous embodiments of the present invention are described in the dependent claims.

The method according to the invention serves for the machining of rotationally symmetric faces of a workpiece with at least one tool.

To this end, the tool has at least one cutting edge that is brought into cutting engagement with the workpiece, namely into a cutting position, in a cutting operation.

According to the invention, the workpiece and/or the tool are driven in rotation.

In accordance with the present invention, the workpiece or the tool is moved in a feed direction with a constant feed in the cutting operation.

In a surface machining operation, the tool and thus the cutting edge remains in the cutting position and the workpiece or the tool is moved in the feed direction, shifted by half the feed.

The surface machining operation is not a conventional cutting operation for generating a rotationally symmetric geometry on the face of the workpiece, but an operation that does not bring about any changes to the workpiece that are visible to the naked eye.

In a preferred, but non-limiting, variant of the method according to the invention, the workpiece is driven in rotation and the tool and thus the cutting edge is fed in radially with respect to the workpiece, namely in a direction normal to an axis of rotation of the workpiece, in the cutting operation and is thus brought into the cutting position.

In the cutting operation, the tool is preferably moved in an axial feed direction, namely in a direction parallel to the axis of rotation of the workpiece, with a constant feed.

In the surface machining operation, the tool and thus the cutting edge remains in the radial cutting position and the tool is moved in the axial feed direction or an axial second feed direction, shifted by half the feed.

In another preferred, but non-limiting, variant of the method according to the invention, the workpiece is driven in rotation and the tool and thus the cutting edge is fed in axially with respect to the workpiece, namely in a direction parallel to an axis of rotation of the workpiece, in the cutting operation and is thus brought into the cutting position.

In the cutting operation, the tool is moved in a radial feed direction, namely a direction normal to the axis of rotation of the workpiece, with a constant feed.

In the surface machining operation, the tool and thus the cutting edge remains in the axial cutting position and the tool is moved in the radial feed direction or a radial second feed direction, shifted by half the feed.

The radial second feed direction corresponds likewise to a direction normal to the axis of rotation of the workpiece but is in the opposite direction to the radial feed direction.

By means of the methods according to the invention, a rotationally symmetric workpiece can be generated via machining, said workpiece being distinguished by an improved surface. In particular, a “finer” and moreover “hard” surface is generated, such that optional subsequent machining steps on the workpiece, for example hardening or grinding can be dispensed with. As a result, the method is optimized in terms of effort and costs.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The invention is described in the following text by way of example with reference to the drawings.

FIG. 1 shows a schematic illustration of the surface of a workpiece after a cutting operation of longitudinal turning.

FIG. 2 shows a schematic illustration of the surface of a workpiece after a surface machining operation of longitudinal turning.

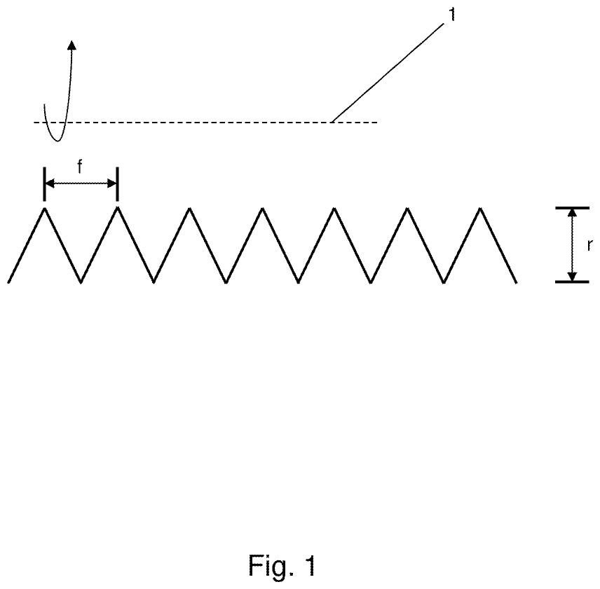

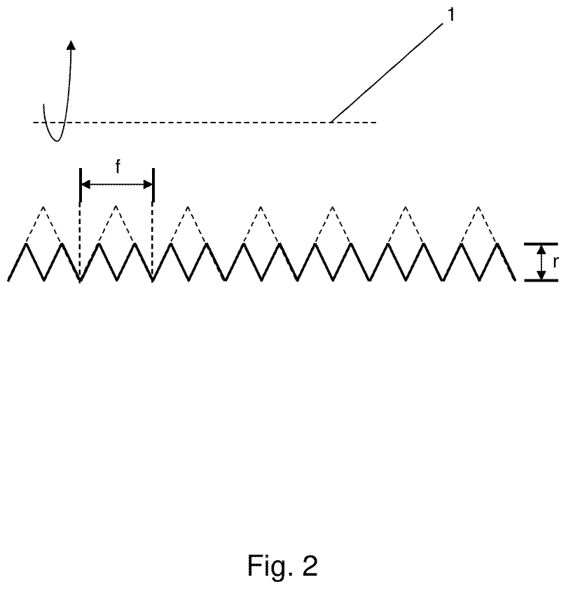

The method according to the invention is described in the following text by way of example on the basis of longitudinal turning of a workpiece. FIG. 1 and FIG. 2 schematically show, with regard thereto, respective surface structures of the workpiece after a cutting operation (FIG. 1) and after a surface machining operation (FIG. 2). The basic configuration of the surface structure after a cutting operation depends on process parameters such as a tool shape, a feed f, etc.

During longitudinal turning, the workpiece is driven in rotation about an axis of rotation 1 and the tool, which comprises a cutting edge, is fed in radially, namely normally to the axis of rotation 1, down to a cutting depth, i.e. brought into a cutting position. During turning, the tool is moved, in a cutting operation, with a constant feed movement parallel to the axis of rotation, namely a feed f, expressed in mm/revolution of the workpiece.

In the cutting operation, the tool is moved in an axial feed direction, namely a direction parallel to the axis of rotation 1 of the workpiece, with a constant feed “f”.

With a constant feed f, a surface structure illustrated in a greatly simplified manner as a “peak/valley” structure in FIG. 1 arises. The spacing of the “peaks” is constant in the direction of the axis of rotation 1 with a constant feed f. The “valley depth”, also known as roughness depth r, depends here on the design of the cutting edge of the tool and on the feed f.

In a surface machining operation following the cutting operation, the tool and thus the cutting edge remain in the radial cutting position and the tool is moved in the axial feed direction, shifted by half the feed f.

This results in a surface structure according to FIG. 2. The original “peaks” have been removed and this results in a surface structure with a reduced roughness depth “r”, with half the roughness depth r in the present highly simplified exemplary embodiment.

What is claimed is:

1. A method for machining a workpiece with at least one tool, wherein the workpiece and/or the tool are driven in rotation, wherein the tool has at least one cutting edge that is brought into cutting engagement with the workpiece, namely into a cutting position, in a cutting operation, and wherein, in the cutting operation, the workpiece or the tool is moved in a feed direction with a constant feed, and wherein, in a surface machining operation, the tool and thus the cutting edge remains in the cutting position and the workpiece or the tool is moved in the feed direction, shifted by half the feed.

2. The method according to claim 1, wherein the workpiece is driven in rotation and the tool and thus the cutting edge is fed in radially with respect to the workpiece, namely in a direction normal to an axis of rotation of the workpiece, in the cutting operation and is thus brought into the cutting position, and wherein, in the cutting operation, the tool is moved in an axial feed direction, namely in a direction parallel to the axis of rotation of the workpiece, with a constant feed, and wherein, in the surface machining operation, the tool and thus the cutting edge remains in the radial cutting position and is moved in the axial feed direction, shifted by half the feed.

3. The method according to claim 1, wherein the workpiece is driven in rotation and the tool and thus the cutting edge is fed in axially with respect to the workpiece, namely in a direction parallel to an axis of rotation of the workpiece, in the cutting operation and is thus brought into the cutting position, and wherein, in the cutting operation, the tool is moved in a radial feed direction, namely a direction normal to the axis of rotation of the workpiece, with a constant feed, and wherein, in the surface machining operation, the tool and thus the cutting edge remains in the axial cutting position and is moved in the radial feed direction, shifted by half the feed.
